(19) United States
(12) Patent Application Publication
(10) Pub. No.: US 2025/0292558 A1
(43) Pub. Date: Sep. 18, 2025

(54) TECHNIQUES FOR TRAINING-BASED IMAGE REPRESENTATION AND COMPRESSION

(71) Applicant: Apple Inc., Cupertino, CA (US)

(72) Inventors: Samson HUANG, Saratoga, CA (US); Crane CHEN, Baltimore, MD (US)

(21) Appl. No.: 18/918,234

(22) Filed: Oct. 17, 2024

Related U.S. Application Data
(60) Provisional application No. 63/566,598, filed on Mar. 18, 2024.

(51) Int. Cl. G06V 10/82; G06T 3/40

(52) U.S. Cl. CPC G06V 10/82; G06T 3/40

(57) ABSTRACT

The present disclosure generally relates to representing an image using a machine learning model.

### CROSS-REFERENCE TO RELATED APPLICATIONS

This application claims priority to U.S. Provisional Patent Application Ser. No. 63/566,598, entitled “TECHNIQUES FOR TRAINING-BASED IMAGE REPRESENTATION AND COMPRESSION,” filed Mar. 18, 2024, which is hereby incorporated by reference herein in its entirety for all purposes.

### BACKGROUND

Electronic devices functionality is becoming increasingly reliant on capture, storage, processing, and/or sharing of images. Accordingly, there is a need to improve techniques related to creating, storing, and/or sharing representations of images.

### SUMMARY

Current techniques for representing compressed image can be in formats such as JPEG, PNG, and GIF. Conventional image compression techniques use a fixed method to process all the images, so that the compression is not optimized for all variations of images, resulting in lost in fidelity and/or bigger file size. This disclosure provides more effective and/or efficient techniques for representing an image using a machine learning model using a framework that utilizes training-based image representation so that optimized image compression is achieved in the process. In addition, techniques optionally complement or replace other techniques for representing compressed image using a machine learning model.

In some embodiments, a method that is performed at a computer system is described. In some embodiments, the method comprises: receiving a first image; and after receiving the first image: in accordance with a determination to send the first image to a first receiver: generating a first neural network model corresponding to the first image; and sending, to the first receiver, the first neural network model without sending the first image; and in accordance with a determination to send the first image to a second receiver different from the first receiver, sending, to the second receiver, a second representation of the first image without sending a neural network model corresponding to the first image.

In some embodiments, a non-transitory computer-readable storage medium storing one or more programs configured to be executed by one or more processors of a computer system is described. In some embodiments, the one or more programs includes instructions for: receiving a first image; and after receiving the first image: in accordance with a determination to send the first image to a first receiver: generating a first neural network model corresponding to the first image; and sending, to the first receiver, the first neural network model without sending the first image; and in accordance with a determination to send the first image to a second receiver different from the first receiver, sending, to the second receiver, a second representation of the first image without sending a neural network model corresponding to the first image.

In some embodiments, a transitory computer-readable storage medium storing one or more programs configured to be executed by one or more processors of a computer system is described. In some embodiments, the one or more programs includes instructions for: receiving a first image; and after receiving the first image: in accordance with a determination to send the first image to a first receiver: generating a first neural network model corresponding to the first image; and sending, to the first receiver, the first neural network model without sending the first image; and in accordance with a determination to send the first image to a second receiver different from the first receiver, sending, to the second receiver, a second representation of the first image without sending a neural network model corresponding to the first image.

In some embodiments, a computer system is described. In some embodiments, the computer system comprises one or more processors and memory storing one or more programs configured to be executed by the one or more processors. In some embodiments, the one or more programs includes instructions for: receiving a first image; and after receiving the first image: in accordance with a determination to send the first image to a first receiver: generating a first neural network model corresponding to the first image; and sending, to the first receiver, the first neural network model without sending the first image; and in accordance with a determination to send the first image to a second receiver different from the first receiver, sending, to the second receiver, a second representation of the first image without sending a neural network model corresponding to the first image.

In some embodiments, a computer system is described. In some embodiments, the computer system comprises means for performing each of the following steps: receiving a first image; and after receiving the first image: in accordance with a determination to send the first image to a first receiver: generating a first neural network model corresponding to the first image; and sending, to the first receiver, the first neural network model without sending the first image; and in accordance with a determination to send the first image to a second receiver different from the first receiver, sending, to the second receiver, a second representation of the first image without sending a neural network model corresponding to the first image.

In some embodiments, a computer program product is described. In some embodiments, the computer program product comprises one or more programs configured to be executed by one or more processors of a computer system. In some embodiments, the one or more programs include instructions for: receiving a first image; and after receiving the first image: in accordance with a determination to send the first image to a first receiver: generating a first neural network model corresponding to the first image; and sending, to the first receiver, the first neural network model without sending the first image; and in accordance with a determination to send the first image to a second receiver different from the first receiver, sending, to the second receiver, a second representation of the first image without sending a neural network model corresponding to the first image.

In some embodiments, a method that is performed at a computer system is described. In some embodiments, the method comprises: receiving a first image of an environment; in response to receiving the first image: generating, based on the first image, a first machine learning model trained to render a two-dimensional representation of the environment; and sending, to a first receiver, the first machine learning model; receiving a second image of the environment, wherein the second image is separate from the first image; and after receiving the first image and the second image: generating, based on the first image and the second image, a second machine learning model trained to render a three-dimensional representation of the environment, wherein the second machine learning model is separate from the first machine learning model; and sending, to a second receiver, the second machine learning model.

In some embodiments, a non-transitory computer-readable storage medium storing one or more programs configured to be executed by one or more processors of a computer system is described. In some embodiments, the one or more programs includes instructions for: receiving a first image of an environment; in response to receiving the first image: generating, based on the first image, a first machine learning model trained to render a two-dimensional representation of the environment; and sending, to a first receiver, the first machine learning model; receiving a second image of the environment, wherein the second image is separate from the first image; and after receiving the first image and the second image: generating, based on the first image and the second image, a second machine learning model trained to render a three-dimensional representation of the environment, wherein the second machine learning model is separate from the first machine learning model; and sending, to a second receiver, the second machine learning model.

In some embodiments, a transitory computer-readable storage medium storing one or more programs configured to be executed by one or more processors of a computer system is described. In some embodiments, the one or more programs includes instructions for: receiving a first image of an environment; in response to receiving the first image: generating, based on the first image, a first machine learning model trained to render a two-dimensional representation of the environment; and sending, to a first receiver, the first machine learning model; receiving a second image of the environment, wherein the second image is separate from the first image; and after receiving the first image and the second image: generating, based on the first image and the second image, a second machine learning model trained to render a three-dimensional representation of the environment, wherein the second machine learning model is separate from the first machine learning model; and sending, to a second receiver, the second machine learning model.

In some embodiments, a computer system is described. In some embodiments, the computer system comprises one or more processors and memory storing one or more programs configured to be executed by the one or more processors. In some embodiments, the one or more programs includes instructions for: receiving a first image of an environment; in response to receiving the first image: generating, based on the first image, a first machine learning model trained to render a two-dimensional representation of the environment; and sending, to a first receiver, the first machine learning model; receiving a second image of the environment, wherein the second image is separate from the first image; and after receiving the first image and the second image: generating, based on the first image and the second image, a second machine learning model trained to render a three-dimensional representation of the environment, wherein the second machine learning model is separate from the first machine learning model; and sending, to a second receiver, the second machine learning model.

In some embodiments, a computer system is described. In some embodiments, the computer system comprises means for performing each of the following steps: receiving a first image of an environment; in response to receiving the first image: generating, based on the first image, a first machine learning model trained to render a two-dimensional representation of the environment; and sending, to a first receiver, the first machine learning model; receiving a second image of the environment, wherein the second image is separate from the first image; and after receiving the first image and the second image: generating, based on the first image and the second image, a second machine learning model trained to render a three-dimensional representation of the environment, wherein the second machine learning model is separate from the first machine learning model; and sending, to a second receiver, the second machine learning model.

In some embodiments, a computer program product is described. In some embodiments, the computer program product comprises one or more programs configured to be executed by one or more processors of a computer system. In some embodiments, the one or more programs include instructions for: receiving a first image of an environment; in response to receiving the first image: generating, based on the first image, a first machine learning model trained to render a two-dimensional representation of the environment; and sending, to a first receiver, the first machine learning model; receiving a second image of the environment, wherein the second image is separate from the first image; and after receiving the first image and the second image: generating, based on the first image and the second image, a second machine learning model trained to render a three-dimensional representation of the environment, wherein the second machine learning model is separate from the first machine learning model; and sending, to a second receiver, the second machine learning model.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system in accordance with some embodiments.

FIG. 2 is a block diagram illustrating a device with interconnected subsystems in accordance with some embodiments.

FIG. 3 is a block diagram illustrating a computer system in accordance with some embodiments.

FIG. 4A-4B illustrate exemplary images for representing using a machine learning model in accordance with some embodiments.

FIG. 5 is a flow diagram illustrating an exemplary process for representing an image using a neural network model.

FIG. 6 is a flow diagram illustrating an exemplary process for generating different machine learning models from image data.

### DETAILED DESCRIPTION

The examples, descriptions, and elements disclosed within are laid out as potential embodiments to describe and expand on the claimed subject matter. It should be recognized that such examples and embodiments are not intended as limiting on the scope of the disclosure but instead are provided as a description of the claimed subject matter.

The methods disclosed herein can include one or more steps that are contingent upon one or more conditions being satisfied. It should be understood that a method can occur over multiple iterations of the same process with different steps of the method being satisfied in different iterations. A person having ordinary skill in the art would also understand that similar to a method with contingent steps, a system or computer readable storage medium can repeat the steps of a method as many times as needed to ensure that all of the contingent steps have been performed. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied.

Additionally, the methods described can be rewritten as repeating until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied.

The present disclosure utilizes numerical descriptors to organize elements without introducing numerous unique identifiers. For example, the terms “first,” “second,” “third,” etc. are utilized to differentiate between like elements. However, such numbering techniques are not used to be limiting, neither denote quantity nor order. For example, a first computing system could be termed a second computing system, and, without departing from the scope of the disclosure, the first computing system could be termed a computing system. Additionally, in some embodiments, the first computing system and the second computing system are two separate references to the same computing system. Alternatively, in some embodiments, the first computing system and the second computing system can be distinct computing system of the same type of computing system or different type of computing systems.

When describing particular embodiments within the present disclosure, the descriptions are enclosed for the purpose of providing clear examples and not for limiting purposes. The description of various embodiments and appended claims include the following singular terminology “a,” “an,” and “the.” However, such terminology is intended to include the plural forms as well, unless clearly stated otherwise. Additionally, the use of “and/or” should be understood as including any and all combinations of the associated listed elements. For example, “A and/or B” includes “A,” “B,” and “A and B.” The use of the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The present disclosure can include conditional language. When using the term “if,” it should be, optionally, construed to mean “when,” “upon,” “in response to determining,” “in response to detecting,” or “in accordance with a determination that” depending on the context. Additionally, when using the phrase “if it is determined” or “if [a stated condition or event] is detected” it should be, optionally, construed to mean “upon determining,” “in response to determining,” “upon detecting [the stated condition or event],” “in response to detecting [the stated condition or event],” or “in accordance with a determination that [the stated condition or event]” depending on the context.

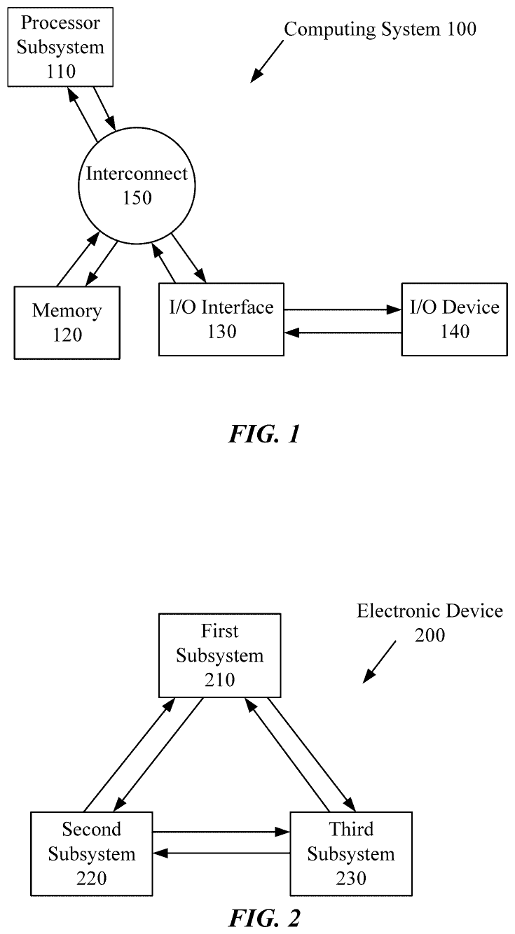

At FIG. 1, computing system 100 is illustrated through a block diagram, including a set of components. In the present disclosure, computing system 100 is used for exemplary purposes and should not be construed as limiting to one type of computing system or to one computer architecture of a computing system. The methods herein can be performed by other computer architectures and other computing systems. Computing system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. Although a single computing system is shown in FIG. 1, computing system 100 can also be implemented as two or more computing systems operating together.

In some embodiments, computing system 100 is included, connected to, or in communication with a physical component for the purpose of modifying the physical component in response to an instruction. Alternatively, in some embodiments, an instruction is received by computing system 100, and in response to the instruction, computing system 100 modifies the physical component. Computing system 100 can, but is not limited to, modify the following physical components: an acceleration control, a break, a gear box, a vacuum system, a motor, a pump, a refrigeration system, a steering control, a pump, a spring, a suspension system, a hinge, and/or a valve. In some embodiments, the physical component is modified via an algorithm, another computing system, an electric signal, and/or actuator.

In some embodiments, computing system 100 includes one or more sensors. In some embodiments, computing system 100 is a sensor. In some embodiments, a sensor includes one or more components designed to obtain information about an environment. In some embodiments, a sensor can be configured to obtain information within its proximity, to obtain information through contact with the environment or an object within the environment, or to obtain information from a specified direction originating from the sensor. Some exemplary sensor components include: a flow sensor, a force sensor, a temperature sensor, a time-of-flight sensor, a leak sensor, a level sensor, a light detection and ranging system, a gas sensor, a humidity sensor, an image sensor (e.g., a radar sensor, a camera sensor, and/or a LiDAR sensor), an angle sensor, a chemical sensor, a brake pressure sensor, a contact sensor, a non-contact sensor, an electrical sensor, an inertial measurement unit, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a metal sensor, a motion sensor, a torque sensor, and an ultrasonic sensor. In some examples, a sensor includes a combination of multiple sensors. In some embodiments, sensor data is captured by fusing data from one sensor with data from one or more other sensors. In some embodiments, a sensor can include one or more components such as a sensing component (e.g., an image sensor or temperature sensor), a transmitting component (e.g., a laser or radio transmitter), a receiving component (e.g., a laser or radio receiver), or any combination thereof.

In the current embodiment, computing system 100 includes multiple subsystems that are connected to and in communication with each other. Through interconnect 150 (e.g., a system bus, one or more memory locations, or other communication channel for connecting multiple components of computing system 100), processor subsystem 110 can communicate with (e.g., wired and/or wirelessly) memory 120 (e.g., system memory, dynamic memory, and/or virtual memory) and I/O interface 130. In some examples, multiple instances of processor subsystem 110 can be communicating via interconnect 150. Additionally, computing system 110 can communicate with additional components (e.g., I/O device 140) through I/O interface 130. In some embodiments, I/O interface 130 is included with I/O device 140 such that the two are a single component. It should be recognized that there can be one or more I/O interfaces, with each I/O interface communicating with one or more I/O devices.

Processor subsystem 110 enables computing system 100 to execute instructions to perform the exemplary disclosure laid out herein. For example, processor subsystem 110 can execute an operating system, a middleware system, one or more applications, or any combination thereof. In some embodiments, processor subsystem 110 includes one or more processors or processing units.

In some embodiments, the instructions required to perform the operations described herein are stored in memory 120 (e.g., through a connected non-transitory or transitory computer readable medium). Computing system 100 can use memory 120 to store (e.g., configured to store, assigned to store, and/or that stores) program instructions executable by processor subsystem 110. For example, memory 120 can store program instructions to implement the functionality associated with methods 800, 900, 1000, 11000, 12000, 1300, 1400, and 1500 described below.

Computing system 100 can utilize a variety of types of memory for storing instructions. In some embodiments, memory 120 can be implemented using different physical, non-transitory memory media, such as flash memory, random access memory (RAM-SRAM, EDO RAM, SDRAM, DDR SDRAM, RAMBUS RAM, or the like), hard disk storage, floppy disk storage, removable disk storage, read only memory (PROM, EEPROM, or the like), or the like.

In some embodiments, computing system 100 is not limited to memory 120 for storage. Computing system 100 can also include other forms of storage such as cache memory in processor subsystem 110 and non-processor storage through I/O interface 130 on I/O device 140 (e.g., a hard drive, storage array, etc.). In some embodiments, instructions to be executed by processor subsystem 110 to perform operations described herein can be stored on these other forms of storage. In some examples, processor subsystem 110 (or each processor within processor subsystem 110) contains a cache or other form of on-board memory.

Computing system 100 utilizes I/O interface 130 to communicate with other devices. In some embodiments, interface 130 includes various types of interfaces configured to effectively communicate with other devices. In some examples, I/O interface 130 includes a bridge chip (e.g., Southbridge) from a front-side bus to one or more back-side buses. In some embodiments, computing system 100 includes one or more I/O interfaces. In some embodiments, I/O interface 130 is capable of communicating with one or more I/O devices (e.g., I/O device 140) via one or more corresponding buses or other interfaces.

I/O devices provide additional functionality to computing system 100 through the associate hardware components included in the I/O device. Some examples of possible I/O devices include: output devices (e.g., auditory, tactile, or visual) (e.g., speaker, light, screen, projector, or the like); network interface devices (e.g., to a local or wide-area network), sensor devices (e.g., camera, ultrasonic sensor, GPS, radar, LiDAR, inertial measurement device, or the like); and storage devices (removable flash drive, storage array, hard drive, optical drive, SAN, or their associated controller). In some embodiments, computing system 100 is communicating with a network via a network interface device (e.g., configured to communicate over Wi-Fi, Bluetooth, Ethernet, or the like). In some embodiments, computing system 100 is directly or wired to the network. In some embodiments, computing system 100 is connected to I/O device 140 through a network connection (e.g., wired and/or wirelessly).

In some embodiments, computing system 100 includes an operating system to manage resources and hardware capabilities. Computing system 100 is compatible with, but not limited to, the following types of operating systems: distributed operating systems (e.g., Advanced Interactive executive (AIX), batch operating systems (e.g., Multiple Virtual Storage (MVS)), time-sharing operating systems (e.g., Unix), network operating systems (e.g., Microsoft Windows Server), and real-time operating systems (e.g., QNX). In some embodiments, the operating system provides additional capabilities to computing system 100 such as various procedures, sets of instructions, software components, and/or drivers for controlling and managing general system tasks (e.g., memory management, storage device control, power management, or the like) and for facilitating communication between hardware and software components. In some embodiments, the operating system controls the order and timing of the tasks to be executed by processor subsystem 110 through a priority-based scheduler. In such embodiments, the priority assigned to a task is used to identify a next task to execute. In some embodiments, the highest priority task runs to completion unless another higher priority task is made ready. In some embodiments, the priority-based scheduler identifies a next task to execute when a previous task finishes executing.

In some embodiments, computing system 100 includes a middleware system to provides one or more services and/or capabilities to applications (e.g., the one or more applications running on processor subsystem 110) outside of what the operating system offers (e.g., authentication, API management, data management, application services, messaging, or the like). In such embodiments, the middleware system can be configured to provide for implementation of commonly used functionality, message-passing between processes, package management, a heterogeneous computer cluster to provide hardware abstraction, low-level device control, or any combination thereof. Examples of middleware systems include, but are not limited to, Robot Operating System (ROS), Lightweight Communications and Marshalling (LCM), PX4, and ZeroMQ.

In some embodiments, the middleware system represents processes and/or operations using a graph architecture. In such embodiments, processing takes place in nodes that can receive, post, and multiplex state messages, planning messages, actuator messages, sensor data messages, control messages, and other messages. In such examples, the graph architecture can define an application (e.g., an application executing on processor subsystem 110 as described above) such that different operations of the application are included with different nodes in the graph architecture.

In some embodiments, a publish-subscribe model is used to provide communication between a first node in a graph architecture to a second node in the graph architecture. In such embodiments, the first node publishes data on a channel in which the second node can subscribe. In some embodiments, the first node can store data in memory (e.g., memory 120 or some local memory of processor subsystem 110) and send an acknowledgement to the second node that the data has been stored in memory. In some embodiments, the first node provides a pointer (e.g., a memory pointer, such as an identification of a memory location) to the second node so that the second node can directly access the memory location where the first node stored the data. In some embodiments, the first node does not need to store the data in memory and provides the second node the data directly, as to not require memory access (e.g., by the first node or the second node).

FIG. 2 illustrates a block diagram of electronic device 200 with interconnected subsystems. In the illustrated embodiment, electronic device 200 includes three different subsystems (i.e., first subsystem 210, second subsystem 220, and third subsystem 230). The subsystems of electronic device 200 are in communication with (e.g., wired or wirelessly) each other, and create a network (e.g., a storage area network, an enterprise internal private network, a campus area network, a personal area network, a local area network, a virtual private network, a wireless local area network, a metropolitan area network, a wide area network, a system area network, and/or a controller area network). Each subsystem of electronic device 200 can be configured or designed with the computer architecture as described in FIG. 1 (i.e., computing system 100). Additionally, while in the illustrated embodiment electronic device 200 contains three subsystems, electronic device 200 can be configured with additional or fewer subsystems.

In some embodiments, electronic device 200 includes alternative layouts or connectivity of electronic device 200's included subsystems. For example, first subsystem 210 connected to second subsystem 220 but not third subsystem 230, or second subsystem 220 connected to third subsystem 230 but not first subsystem 210. In some embodiments, electronic device 200's subsystems are electrically connected while additional subsystems are wireless connected to electronic device 200. In some embodiments, subsystems of electronic device 200 are configured to send messages between and receive messages from other subsystems of electronic device 200. In some embodiments, the subsystems can be configured to communicate wirelessly to the one or more computer systems outside of device 200. In such embodiments, one or more subsystems are wirelessly connected to one or more computer systems outside of device 200, such as a server system.

In some embodiments, one or more subsystems of electronic device 200 are used to control, manage, and/or receive data from one or more other subsystems of electronic device 200 and/or one or more additional computer systems (e.g., electrically connected or remote from electronic device 200). For example, first subsystem 210 and second subsystem 220 can each be a camera that captures images, and third subsystem 230 can use the captured images for decision making. In some embodiments, at least a portion of electronic device 200 functions as a distributed computer system. For example, a first portion of a task is executed by first subsystem 210 and a second portion of the task is executed by second subsystem 220.

In some embodiments, electronic device 200 includes an enclosure that fully or partially houses electronic device 200's subsystems (e.g., subsystems 210-230). Potential enclosures include, but are not limited to, a head-mounted-display device, a smart display, a home-appliance device (e.g., a refrigerator or an air conditioning system), an accessory device, a smart phone, a smart watch, a robot (e.g., a robotic arm or a robotic vacuum), and a vehicle. In some embodiments, electronic device 200 is capable of navigating a physical environment with or without user input.

Attention is now directed towards techniques for representing an image using a machine learning model. Such techniques are described in the context of components of an electronic device (e.g., and/or system). It should be recognized that other types of components, electronic devices, and/or systems can be used with techniques described herein. For example, an accessory can share image representations with a smartphone using techniques described herein. For another example, a vehicle can provide image representations between components of the vehicle using techniques described herein. In addition, techniques optionally complement or replace other techniques for controlling output components.

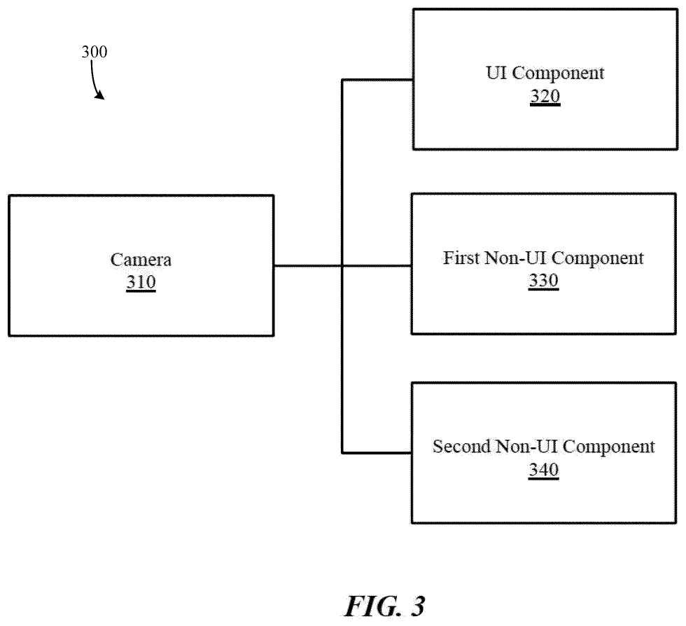

FIG. 3 illustrates a functional block diagram of computer system 300 in accordance with some embodiments. Computer system 300 includes camera 310. In some embodiments, camera 310 is a component that is configured to (e.g., capable of performing and/or being used to perform) capture one or more images of an environment (e.g., a physical environment and/or a virtual environment). In some embodiments, camera 310 includes one or more cameras. In some embodiments, a camera is and/or includes an image capture component that includes one or more optical elements, sensors, and/or mediums for capturing, recording, and/or storing representations of light (e.g., in the form of an image).

As illustrated in FIG. 3, computer system 300 includes user interface (UI) component 320. In some embodiments, UI component 320 includes one or more components used to generate a user interface and/or portion thereof. For example, UI component 320 can include one or more software and/or hardware components used to generate and/or display a user interface viewable by a user (e.g., which can include representations of images captured by camera 310). In some embodiments, computer system 300 includes two or more UI components (e.g., similar to, the same as, and/or different than UI component 320).

As illustrated in FIG. 3, computer system 300 includes first non-UI component 330. In some embodiments, first non-UI component 330 includes one or more components used to perform one or more operations that do not result in generation and/or display of a user interface. For example, first non-UI component 330 can include one or more software and/or hardware components used to determine values for the size, distance, and/or velocity of an object detected in an image captured by camera 310 (e.g., where such values are stored in memory and/or provided to one or more other operations rather than being presented via a user interface).

As illustrated in FIG. 3, computer system 300 includes second non-UI component 340. In some embodiments, second non-UI component 340 includes one or more components used to perform one or more operations that do not result in generation of a user interface. In some embodiments, first non-UI component 330 is the same as second non-UI component 340. In some embodiments, first non-UI component 330 is different from second non-UI component 340. In some embodiments, computer system 300 includes additional non-UI components (e.g., similar to, the same as, and/or different than non-UI component 330 and/or non-UI component 340).

In some embodiments, computer system 300 includes fewer, additional, and/or different components than illustrated in FIG. 3. In some embodiments, computer system 300 includes one or more components, features, and/or functions as described herein with respect to computing system 100 and/or electronic device 200.

In some embodiments, computer system 300 includes a physical enclosure. In some embodiments, computer system 300 is moveable (e.g., moveable under its own power, moveable by the power of one or more external devices, and/or moveable by a user). For example, computer system 300 can be placed within a user's home, affixed to another device, and/or move itself (e.g., rotate and/or translate such that a point of view of camera 310 changes).

In some embodiments, one or more components of computer system 300 (e.g., camera 310, UI component 320, first non-UI component 330, second non-UI component 340, and/or another component) are connected via one or more wired connections and/or wireless connections to each other and/or another component (e.g., a processing component) of computer system 300. In some embodiments, one or more components of computer system 300 communicate via shared memory and/or non-shared memory (e.g., sending content in a message and/or sending content as pointer)

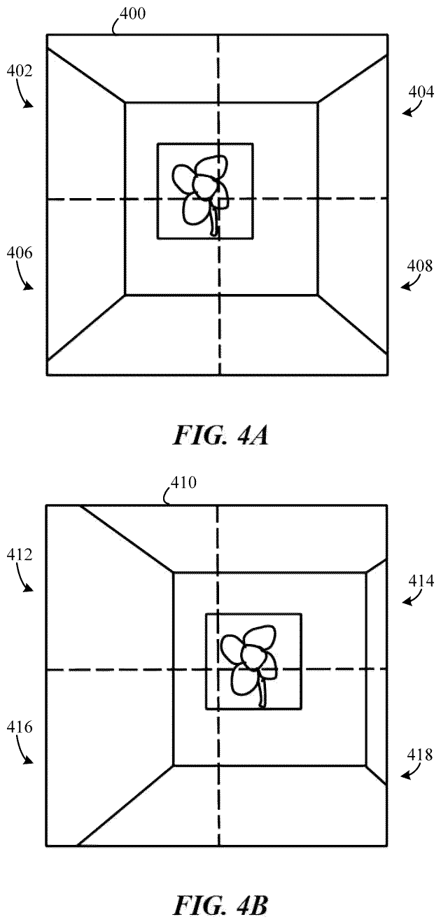

FIGS. 4A-4B illustrate images of an environment captured from two different perspectives (e.g., locations and/or camera poses within an environment). In the examples of FIGS. 4A-4B, a camera (e.g., camera 310) (and/or one or more other components) captures a first image from a first perspective (e.g., image 400) and subsequently captures a second image from a second perspective (e.g., image 410). For example, camera 310 moves (e.g., by moving itself and/or by movement caused by a user and/or an external component) such that the perspective of image 410 is shifted slightly to the left as compared to image 400 (e.g., the dotted lines intersect further to the left of the object on the wall (e.g., a painting of a flower)). In this example, image 400 and image 410 are captured by camera 310. In some embodiments, image 400 and image 410 are captured by different cameras. In some embodiments, image 400 and image 410 are captured at different times (e.g., by the same or different camaras). In some embodiments, image 400 and image 410 are captured at the same time (e.g., by different camaras).

In the examples of FIGS. 4A and 4B, image 400 and image 410 are two-dimensional images. In some embodiments, a captured image is a three-dimensional image (e.g., includes and/or corresponds to information representing spatial depth).

In some embodiments, camera 310, UI component 320, first non-UI component 330, second non-UI component 340, and/or another component stores a representation of a captured image (e.g., in memory). For example, the representation of the captured image can be a compressed representation of the image (e.g., applying and/or performing a data compression process to encode information (e.g., bits defining image 400) using fewer bits than an original representation). In some embodiments, the representation of a captured image is uncompressed. In some embodiments, a representation of the image is stored in local memory and/or remote memory (e.g., external device and/or a server).

### Encoding and Decoding as an ML Model for Image Compression

Attention is now turned to example techniques for creating and/or storing a compressed representation of captured images. In some embodiments, a compressed representation (also referred to herein as an “encoded representation”) of a captured image (e.g., image 400) includes and/or is a machine learning (ML) model. In some embodiments, the ML model is a neural network (NN) (e.g., an artificial neural network).

In some embodiments, the ML model includes and/or is a Neural Radiance Field (NeRF) model. A NeRF model is a technique for constructing a three-dimensional representation of a scene from sparse two-dimensional images, introduced by Ben Mildenhall, et al, in the paper titled “NeRF: Representing Scenes as Neural Radiance Fields for View Synthesis” and published in March 2020. As described by Mildenhall, et al, in the aforementioned paper, a NeRF model can be used to generate a two-dimensional view (e.g., a novel view) of a three-dimensional shape (e.g., a representation of a scene, an environment, and/or an object) from a set of two-dimensional images (e.g., of the scene, environment, and/or object) with a known camera pose.

In some embodiments, the ML model, used to represent a compressed representation of an image, includes trainable parameters. In some embodiments, an ML model is trained (e.g., by camera 310, computer system 300, and/or another device and/or component) using as input a set of one or more images such that the trained ML model represents the image. For example, an ML model can be trained using image 400, wherein the resulting trained ML model is a representation of image 400 that can be used to recreate a representation of image 400.

With respect to a trained ML model that represents an image (and/or a set of images), the trained ML model can effectively be a compressed version of the image when the trained ML model uses less memory to store and/or transmit than the original image (e.g., the uncompressed image used to train the ML model) (e.g., the file size of the ML model is smaller than the file size of uncompressed image). Further, characteristics of ML models can enable recreation of the original image (e.g., image 400) at arbitrary resolutions. For example, a representation of the image can be recreated by inferencing a neural network model to create a representation of the image represented by the neural network model. In some embodiments, the arbitrary resolution of the created image can be lower than, higher than, or equal to the resolution of the original image. For example, a requestor (e.g., a process and/or device) can specify a size and/or viewpoint of an object represented by a NeRF model, and a neural network of the NeRF model can be inferenced to generate the representation using the trained parameters. In some embodiments, the size (e.g., file size) of the created image can be lower than, higher than, or equal to the size of the original image.

### Applying ML Model Compression to Represent Individual Images

As described in the section above, ML models can be used to generate a two-dimensional view of a three-dimensional shape from a set of two-dimensional images, having known camera poses, of the shape. For example, multiple images from different perspective surrounding a three-dimensional object are used as input to create a NeRF model that represents the object in three-dimensions.

Attention is now directed to a technique for applying ML model compression to an individual image (e.g., a two-dimensional image) to achieve compression. As described above, FIG. 4A illustrates captured image 400 which is an individual image captured by camera 310. In some embodiments, an image is down sampled (e.g., divided, subdivided, and/or subsampled) to create a set of multiple images (e.g., a set of two or more images). For example, in FIG. 4A, image 400 is divided into a set of four images, image 402, image 404, image 406, and image 408. In some embodiments, the images of the set of multiple images do not include overlapping image data. For example, in FIG. 4A image 402 includes image data not included in the other images (e.g., 404, 406, and 408) of the set of multiple images. In other embodiments, the images of the set of multiple images includes overlapping image data.

Turning to FIG. 4B, image 410 is down sampled to create a set of multiple images that includes image 412, image 414, image 416, and image 418. In FIG. 4B, image 410 is divided into four images, as described with respect to image 400 of FIG. 4A above. While the examples of FIGS. 4A and 4B illustrated a simple dividing of the images into 4 images, more complex subdivisions can be made.

In some embodiments, an image is down sampled into any number of images. In some embodiments, each down sampled image is unique from others in the set if down sampled in a manner that ensures non-overlapping portions (e.g., pixel data) of the original image. In some embodiments, a down sampled image is created by sampling every Nth horizontal pixel in the horizonal direction and every Nth vertical pixel in the vertical direction, which results in a set of down sampled images after the sampling pattern is performed such that each pixel of the original image is represented in a down sampled image. For example, an image is a two-dimensional set of pixels that are subsampled according to a subsampling area of N-by-N pixels that is repeated contiguously over the set of pixels defining the image. For example, for the case N=2 the total number of resulting subsampled images is N2, which in this example is four (e.g., there are four locations within a subsampling area defined by two horizontal pixels and two vertical pixels). In the N=2 example, an original image that is a four pixel square will result in a four images each having one pixel of resolution (e.g., as illustrated by the pattern on image 400 of FIG. 4A), whereas an original image that is 16,000 pixels will result in four images each having 4,000 pixels of resolution. In some embodiments, the subsampling area is a different size (e.g., N=3, 4, 5, 6, . . . , or n) and/or shape than N-by-N. For example, a subsampling area of N-by-N pixels that uses N=4 results in a set of 16 down sampled images.

In some embodiments, a set of down sampled images include images that have overlapping field-of-view (e.g., of the scene and/or object in the original image). For example, if an original image is 16 million pixels arranged as a 4,000 pixel by 4,000 pixel square and a subsampling area of N-by-N pixels is use, where N=4, then the subsampling area will be repeated along the horizontal direction a total of 1,000 times (e.g., the subsampling area has a horizontal length of 4 pixels, so to cover the entire original image the subsampling area is repeated 1,000 times to ensure the original image is sampled along the entirety of its horizontal dimension). In this example, the subsampling area will be repeated along the vertical direction a total of 1,000 times for the same reason. The result will be 16 down sampled images that each include pixels from all over the area of the two-dimensional original image (e.g., each image includes 1/16th of the pixels of the original image).

In some embodiments, the set of multiple images created by subsampling an image (e.g., image 400) are used as input to train a neural network (e.g., train parameters thereof) to create an ML model that represents the object. For example, images 402, 404, 406, and 408 are used to train a NeRF model that represents image 400. In some embodiments, the resulting NeRF model of image 400 is a compressed representation of image 400 (e.g., takes up less storage space in memory and/or results in a smaller message size when sending). For example, camera 310 can store the NeRF model representing image 400 instead of storing image 400, saving storage space in memory.

### Creating a Representation from a Compressed Representation

Attention is now directed to techniques for selectively providing versions of an image based on identity of a receiver (e.g., process, component, and/or device). In the description above, several distinct versions of an image are described: for example, an original captured version of image 400 (e.g., uncompressed original), an ML model representing image 400 (e.g., a NeRF model) (e.g., a compressed representation), and a recreated representation of image 400 (e.g., recreated from the ML model) (e.g., of an arbitrary resolution).

In some embodiments, camera 310 determines that a representation of image 400 (and/or image 410) should be sent to a receiver (e.g., UI component 320, first non-UI component 330, second non-UI component 340, and/or another component). In some embodiments, in accordance with a determination that the receiver is a first receiver (e.g., first type of receiver, a receiver having a particular identity, a class of receivers, and/or a predetermined group of receivers), camera 310 provides a first representation of image 400 to the first receiver, wherein the first representation is an ML model. For example, the first receiver can be associated with a type of process and/or function that is preferably provided robust data (e.g., a critical process such as a safety process) (e.g., the first receiver is a process that includes semantic segmentation and/or object detection for mapping a surrounding physical environment). For example, by providing the ML model, the first receiver can generate representations of image 400 as needed (e.g., and at arbitrary resolutions).

Some receivers require and/or benefit from robust data (e.g., image data that has been minimally compressed or not compressed at all). For example, such receivers can use such data for processes related to safety and/or privacy wherein such robust data is needed to reduce and/or eliminate unacceptable false positive and/or false negative determinations based on the data. In some embodiments, in accordance with a determination that the receiver is a second receiver (e.g., second type of receiver, a receiver having a particular identity, a class of receivers, and/or a predetermined group of receivers), camera 310 provides a second representation of image 400 to the second receiver, wherein the second representation is a first image generated from an ML model representation of image 400. For example, the second receiver can be associated with a type of process and/or function that is preferably provided robust data (e.g., a critical process such as a safety process) (e.g., the first receiver is a process that includes semantic segmentation and/or object detection for mapping a surrounding physical environment). In some embodiments, the second receiver is the same as and/or different from the first receiver. In this example, however, camera 310 provides an image (e.g., the second representation) rather than (and/or in addition to) the ML model. For example, by providing the second representation which is an image, the second receiver does not need to use the ML model to generate an image. In some embodiments, the second representation is a lossy format. In some embodiments, the second representation is a non-lossy format.

In other examples, some receivers do not require and/or benefit from robust data. For example, such receivers can use such data for processes that are not critical (e.g., related to safety and/or privacy) and/or for processes where reduced use of resources is beneficial (e.g., due to processing and/or storing smaller sets of data). In some embodiments, in accordance with a determination that the receiver is a third receiver (e.g., third type of receiver, a receiver having a particular identity, a class of receivers, and/or a predetermined group of receivers), camera 310 provides a third representation of image 400 to the third receiver, wherein the third representation is a first image generated from an ML model representation of image 400. In some embodiments, the third representation is a lower resolution (and/or file size) representation than the second representation (and/or the first representation and/or the original uncompressed image (e.g., image 400)). For example, the third receiver can be associated with a type of process and/or function that does not require robust data (e.g., is a UI component that causes the image to be displayed via a display generation component of limited resolution). In some embodiments, the third receiver is the same as and/or different from the first and/or second receiver. In this example, however, camera 310 provides an image (e.g., the third representation) rather than (and/or in addition to) the ML model. For example, by providing the third representation which is an image, the third receiver does not need to use the ML model to generate an image. In some embodiments, the third representation is a lossy format. In some embodiments, the third representation is a non-lossy format.

In some embodiments, the file size of the second representation and/or the file size of the third representation is smaller than the file size of the first representation. For example, an image representation generated from an ML model has a smaller file size than the ML model. In some embodiments, the file size of the second representation and/or the file size of the third representation is larger than the file size of the first representation. For example, an image representation generated from an ML model has a larger file size than the ML model (e.g., is generated at a high resolution from the ML model).

In some embodiments, camera 310 provides the first representation, the second representation, and/or the third representation in conjunction with each other (e.g., simultaneously and/or serially in time) (e.g., in response to the same trigger, event, determination and/or input).

In the examples described above, reference is made to camera 310 performing various actions (e.g., providing and/or storing representations of an image, generating an ML model, and/or generating representations of an image represented by an ML model). In some embodiments, such actions described above with respect to camera 310 can be performed by one or more components (e.g., that are camera 310, that include camera 310, and/or that exclude camera 310) (e.g., UI component 320, first non-UI component 330, second non-UI component 340, and/or another component). For example, camera 310 captures the original image (e.g., image 400), after which a separate component (e.g., of computer system 300 and/or a different device) generates an ML model representation of the original image (e.g., off-camera processing).

### Generated 2D and 3D Representations from the Same Image Data

Attention is now turned to techniques for generating two-dimensional and three-dimensional representations from common image data. With reference to FIGS. 4A and 4B, image 400 and image 410 can be captured serially in time by the same camera 300 moving along a path. In some embodiments, each of image 400 and image 410 are subsampled and used to train an ML model as described above (e.g., resulting in two ML models, one representing image 400 and one representing image 410). In some embodiments, a plurality of images (and/or ML models representing such images) are used to generate a three-dimensional model (e.g., ML model such as a NeRF model and/or other neural network) of a scene and/or object. For example, the ML models representing image 400 and image 410 (and/or the images themselves) can be used to train a different ML model that represents a three-dimensional model of the room that is depicted in the scene captured by the images in FIGS. 4A and 4B. In some embodiments, the plurality of images must include different viewpoints (e.g., of a scene and/or object). For example, image 410 includes a slightly different viewpoint than image 400, which enables generating three-dimensional ML model representing the three-dimensional scene.

As described above with respect to receivers having differing needs for resolution and/or file size, camera 310 can provide the two-dimensional models and three-dimensional models to different receivers. For example, the three-dimensional ML model can be sent to UI component 320 whereas the two-dimensional ML models (representing two-dimensional image 400 and image 410) are sent to first non-UI component 330). In some embodiments, camera 310 (and/or computer system 300) renders and/or causes to render a representation of a two-dimensional ML model and/or the three-dimensional ML model. In some embodiments, camera 310 performs the rendering in response to user input. For example, a user of computer system 300 can desire to view an interactive three-dimensional visual model of the room depicted in the scene of image 400 and image 410. In this example the three-dimensional ML model (e.g., created from the two-dimensional models) can be used to generate the interactive three-dimensional visual model.

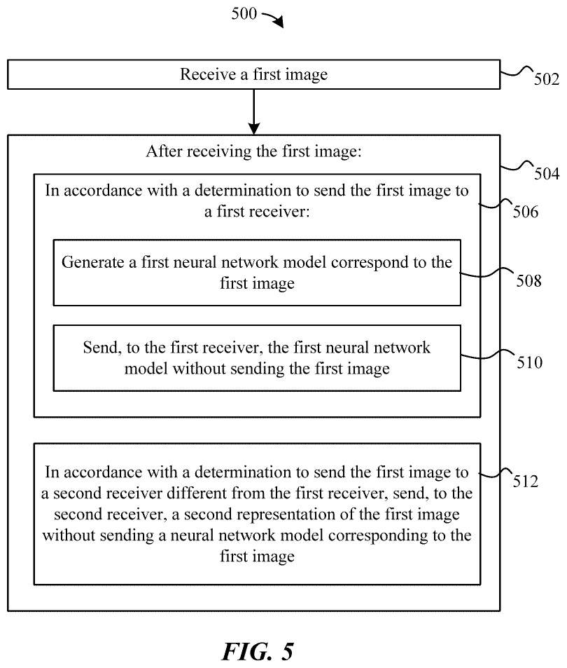

FIG. 5 is a flow diagram illustrating a method (e.g., method 500) for representing an image using a neural network model in accordance with some embodiments. Some operations in method 500 are, optionally, combined, the orders of some operations are, optionally, changed, and some operations are, optionally, omitted.

As described below, method 500 provides an intuitive way for representing an image using a neural network model. Method 500 reduces the cognitive burden on a user, thereby creating a more efficient human-machine interface. For battery-operated computing devices, enabling a user to interact with such devices faster and more efficiently conserves power and increases the time between battery charges.

In some embodiments, method 500 is performed at a computer system (e.g., 100, 200, 300) (e.g., at a first process and/or a first application (e.g., a system and/or user application) of the computer system). In some embodiments, the computer system is a watch, a phone, a tablet, a fitness tracking device, a processor, a head-mounted display (HMD) device, a communal device, a media device, a movable and/or mobile device, a speaker, a television, a camera, and/or a personal computing device.

The computer system receives (502) (e.g., via a camera (e.g., a periscope camera, a telephoto camera, a wide-angle camera, and/or an ultra-wide-angle camera) and/or a device in communication with the computer system) a first image (e.g., 400 and/or 410) (e.g., a two-dimensional or a three-dimensional image).

After receiving (504) the first image, in accordance with a determination (506) to send the first image to a first receiver (e.g., 320, 330, and/or 340) (e.g., a UI compute process, configured to generate and/or display displayable content), the computer system generates (508) a first neural network model corresponding to the first image.

After receiving (504) the first image, in accordance with the determination (506) to send the first image to the first receiver, the computer system sends (510), to the first receiver, the first neural network model without sending the first image.

After receiving (504) the first image, in accordance with a determination to send the first image to a second receiver (e.g., 320, 330, and/or 340) (e.g., non-UI compute process, such as a security process and/or a critical component) (e.g., of the computer system or another computer system different from the computer system) different from the first receiver, the computer system sends (512), to the second receiver, a second representation (e.g., a first encoded (e.g., encoded via a first encoding technique), compressed (e.g., compressed via a first compression technique), and/or a non-encoded version) (e.g., a lossy or non-lossy format) of the first image (e.g., 400 and/or 410) without sending a neural network model corresponding to the first image (and/or without sending the first image). In some embodiments, the second representation is the first image. In some embodiments, the first neural network model is sent without sending the second representation.

In some embodiments, generating a first neural network model corresponding to the first image includes: down sampling (and/or subdividing and/or subsampling) the first image (e.g., 400 and/or 410) to generate a second image (e.g., 402, 404, 406, and/or 408) and a third image separate (e.g., 402, 404, 406, and/or 408) (and/or different) from the second image. In some embodiments, the second image is different from the first image. In some embodiments, the third image is different from the first image. In some embodiments, down sampling the first image generates a plurality of images, each image having a resolution of one over the number of the plurality of images. In some embodiments, generating the first neural network model corresponding to the first image includes: training (e.g., at the computer system and/or another computer system (e.g., a server, a watch, a phone, a tablet, a fitness tracking device, a processor, a head-mounted display (HMD) device, a communal device, a media device, a movable and/or mobile device, a speaker, a television, and/or a personal computing device) different from the computer system) (and/or causing training, by the other computer system, of) the first neural network model using the second image and the third image (e.g., without using the first image).

In some embodiments, the second image (e.g., 402, 404, 406, and/or 408) does not include data (e.g., image data) of the first image (e.g., 400 and/or 410) included in the third image (e.g., 402, 404, 406, and/or 408). In some embodiments, the third image does not include data (e.g., image data) of the first image included in the second image. In some embodiments, the second image includes data (e.g., image data) of the first image included in the third image. In some embodiments, the second image includes data (e.g., image data) of the first image not included in the third image. In some embodiments, the third image includes data (e.g., image data) of the first image not included in the second image.

In some embodiments, the first neural network model is a first size (e.g., file and/or memory size). In some embodiments, the first image (e.g., 400 and/or 410) is a second size larger than the first size. In some embodiments, the second size is smaller than the first size.

In some embodiments, the first neural network model is a third size (e.g., file and/or memory size). In some embodiments, the second representation is a fourth size smaller than the third size (e.g., the second representation is more compressed version of the first image than the first neural network model). In some embodiments, the fourth size is larger than the third size.

In some embodiments, the first image (e.g., 400 and/or 410) is received via (and/or from) a camera (e.g., the camera captures the first image).

In some embodiments, the second representation is an encoded version of the first image (e.g., 400 and/or 410). In some embodiments, after (and/or in response to) receiving the first image and in accordance with a determination to send the first image to a third receiver (e.g., 320, 330, and/or 340) (e.g., a UI and/or a non-UI compute process) (e.g., of the computer system or another computer system different from the computer system) different from the first receiver (e.g., 320, 330, and/or 340) and the second receiver (e.g., 320, 330, and/or 340), the computer system sends, to the third receiver, the first image (e.g., without encoding and/or compressing the first image) without sending the second representation and without sending a neural network model corresponding to the first image. In some embodiments, after (and/or in response to) receiving the first image, the computer system sends the first neural network model to the first receiver, the second representation to the second receiver, and/or the first image to the third receiver (e.g., in accordance with a determination to send the first image to one or more of the first receiver, the second receiver, and the third receiver).

In some embodiments, the first neural network model is a Neural Radiance Field.

In some embodiments, the computer system stores, in first long-term storage (e.g., at memory (e.g., at a device including the computer system and/or at a server) in communication with the computer system), the first neural network model (e.g., before and/or without determining to send the first neural network model to a receiver) (e.g., as a compressed representation of the first image) (e.g., without storing, in second long-term storage (e.g., the first long-term storage, another long-term storage different from the first long-term storage, and/or any long-term storage), the first image).

In some embodiments, in conjunction with sending the first neural network model, the computer system sends the second representation.

Note that details of the processes described above with respect to method 500 (e.g., FIG. 5) are also applicable in an analogous manner to other methods described herein. For example, method 500 optionally includes one or more of the characteristics of the various methods described above with reference to method 500. For example, the first machine learning model of method 600 can be the first neural network model of method 500. For brevity, these details are not repeated herein.

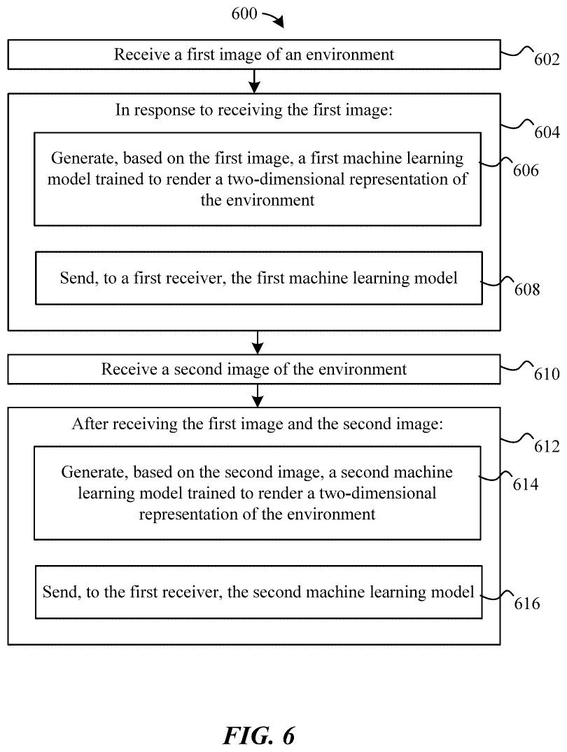

FIG. 6 is a flow diagram illustrating a method (e.g., method 600) for generating different machine learning models from image data in accordance with some embodiments. Some operations in method 600 are, optionally, combined, the orders of some operations are, optionally, changed, and some operations are, optionally, omitted.

As described below, method 600 provides an intuitive way for generating different machine learning models from image data. Method 600 reduces the cognitive burden on a user, thereby creating a more efficient human-machine interface. For battery-operated computing devices, enabling a user to interact with such devices faster and more efficiently conserves power and increases the time between battery charges.

In some embodiments, method 600 is performed at a computer system (e.g., at a first process and/or a first application (e.g., a system and/or user application) of the computer system). In some embodiments, the computer system is a watch, a phone, a tablet, a fitness tracking device, a processor, a head-mounted display (HMD) device, a communal device, a media device, a movable and/or mobile device, a speaker, a television, and/or a personal computing device.

The computer system receives (602) (e.g., via a camera (e.g., a periscope camera, a telephoto camera, a wide-angle camera, and/or an ultra-wide-angle camera) and/or a device in communication with the computer system) a first image (e.g., 400 and/or 410) of an environment.

In response to receiving (604) the first image, the computer system generates (606), based on (and/or using) the first image (e.g., 400 and/or 410), a first machine learning model trained to render a two-dimensional representation of the environment.

In response to receiving (604) the first image, the computer system sends (608), to a first receiver (e.g., 320, 330, and/or 340) (e.g., a UI compute process, configured to generate and/or display displayable content), the first machine learning model.

The computer system receives (610) (e.g., via the camera, another camera different from the camera, the device, and/or another device different from the device in communication with the computer system) a second image (e.g., 400 and/or 410) of the environment, wherein the second image is separate from the first image (e.g., 400 and/or 410). In some embodiments, the second image is received with the first image. In some embodiments, the second image is received after the first image.

After receiving (612) the first image and the second image (and/or in response to receiving the first image and/or the second image) (and/or after receiving a threshold number (e.g., more than one image) of images), the computer system generates (614), based on (and/or using) the first image (e.g., 400 and/or 410) and the second image (e.g., 400 and/or 410), a second machine learning model trained to render a three-dimensional representation of the environment, wherein the second machine learning model is separate from the first machine learning model. In some embodiments, the second machine learning model is a different type of machine learning model than the first machine learning model.

After receiving (612) the first image and the second image, the computer system sends (616), to a second receiver (e.g., 320, 330, and/or 340) (e.g., the first receiver and/or another receiver different from the first receiver), the second machine learning model (e.g., without sending the first machine learning model).

In some embodiments, after receiving the first image (e.g., 400 and/or 410) and the second image (e.g., 400 and/or 410) (and/or in response to receiving the first image and/or the second image) (and/or after receiving a threshold number (e.g., more than one image) of images), the computer system generates, based on (and/or using) the second image (e.g., without using and/or not based on the first image), a third machine learning model trained to render a two-dimensional representation of the environment, wherein the third machine learning model is separate from the first machine learning model and the second machine learning model. In some embodiments, after receiving the first image and the second image, the computer system sends, to the first receiver (e.g., 320, 330, and/or 340), the third machine learning model (e.g., without sending the first machine learning model and/or the second machine learning model) (e.g., machine learning models for rending two-dimensional representations are generated continuously and/or in real-time as images are received).

In some embodiments, the computer system is in communication with a camera (e.g., a periscope camera, a telephoto camera, a wide-angle camera, and/or an ultra-wide-angle camera). In some embodiments, the first image (e.g., 400 and/or 410) and the second image (e.g., 400 and/or 410) are received via (and/or from) the camera (e.g., the camera captured the first image and the second image). In some embodiments, the first image and the second image are included in a single image stream.

In some embodiments, the first machine learning model is a neural network model. In some embodiments, the first machine learning model, the second machine learning model, and/or the third machine learning model is a neural network model. In some embodiments, the first machine learning model, the second machine learning model, and the third machine learning model are the same type of machine learning model (e.g., a neural network model). In some embodiments, the first machine learning model and the third machine learning model are the same type of machine learning model. In some embodiments, the first machine learning model is a different type of machine learning model than the second machine learning model.

In some embodiments, the computer system causes display, via a display component (e.g., a display screen, a display, a projector, and/or a touch-sensitive display) (e.g., in communication with and/or of the computer system, the first receiver and/or the second receiver), of a third image (e.g., similar to and/or different from image 400) separate from the first image (e.g., 400 and/or 410) (and/or the second image), wherein the third image corresponds to the first image (e.g., and not the second image), and wherein the third image is rendered from (and/or by and/or using) the first machine learning model. In some embodiments, the computer system causes display of the third image by sending, to the first receiver, the first machine learning model. In some embodiments, the computer system causes display, via a display component (e.g., a display screen, a display, a projector, and/or a touch-sensitive display) (e.g., in communication with and/or of the computer system, the first receiver and/or the second receiver), of a fourth image separate from the first image, the second image, and/or the third image. In some embodiments, the fourth image corresponds to the second image (e.g., and not the first image). In some embodiments, the fourth image is rendered from (and/or by and/or using) the third machine learning model. In some embodiments, the computer system causes display of the fourth image by sending, to the first receiver, the third machine learning model. In some embodiments, the computer system causes display, via a display component (e.g., a display screen, a display, a projector, and/or a touch-sensitive display) (e.g., in communication with and/or of the computer system, the first receiver and/or the second receiver), of a fifth image separate from the first image, the second image, the third image, and/or the fourth image. In some embodiments, the fifth image corresponds to the first image and the second image. In some embodiments, the fifth image is rendered from (and/or by and/or using) the second machine learning model. In some embodiments, the computer system causes display of the fifth image by sending, to the second receiver, the second machine learning model.

In some embodiments, after sending, to the second receiver (e.g., 320, 330, and/or 340), the second machine learning model, the computer system detects, via an input device (e.g., a camera, a depth sensor, a microphone, a hardware input mechanism, a rotatable input mechanism, a heart monitor, a temperature sensor, and/or a touch-sensitive surface) (e.g., in communication with and/or of the computer system, the first receiver, and/or the second receiver), an input (e.g., corresponding to a request to display an image rendered from, by, and/or using, the second machine learning model) (e.g., user input). In some embodiments, in response to detecting the input, the computer system causes rendering of (and/or renders) a fourth image (e.g., similar to and/or different from image 400) by (and/or using) the second machine learning model.

In some embodiments, the computer system is executing the first receiver (e.g., 320, 330, and/or 340) (e.g., the first machine learning model and/or the third machine learning model are sent locally on the computer system). In some embodiments, another computer system (e.g., a personal device and/or a server), different from the computer system, is executing the second receiver (e.g., 320, 330, and/or 340) (e.g., the second machine learning model is not sent locally on the computer system but rather is sent non-locally).

In some embodiments, the first image (e.g., 400) corresponds to a first view point. In some embodiments, the second image (e.g., 410) corresponds to a second view point (e.g., due to and/or as a result of device motion) different from the first view point. In some embodiments, another image that does not correspond to a different view point is not used to generate a machine learning model using multiple images. In some embodiments, a determination is performed for whether an image is from a different view point before being used to generate a machine learning model using multiple images.

In some embodiments, the first image (e.g., 400) is captured at a different time than (e.g., before or after) the second image (e.g., 410).

Note that details of the processes described above with respect to method 600 (e.g., FIG. 6) are also applicable in an analogous manner to the methods described herein. For example, method 500 optionally includes one or more of the characteristics of the various methods described above with reference to method 600. For example, the first machine learning model of method 600 can be the first neural network model of method 500. For brevity, these details are not repeated herein.

The present disclosure has been laid out above referencing specific examples. However, such examples and descriptions are not intended limit the disclosure to those embodiments contained herein and are not intended to be exhaustive. Many modifications and variations are possible in view of the above teachings. The examples were chosen and described in order to best explain the principles of the techniques and their practical applications. An individual skilled in the art would thereby be enabled to utilize the present disclosure as laid out, and enabled to best utilize the techniques and various examples with various modifications as are suited to the particular use contemplated.

While the present disclosure and examples are accompanied by references to specific drawings, it is to be noted that various changes and modifications will become apparent to those skilled in the art. Such changes and modifications are to be understood as being included within the scope of the disclosure and examples as defined by the claims.

As described above, the present technology improves how a device interacts with a user by gathering and using data from various available sources. In some embodiments, this data can include personal data (e.g., demographic data, location-based data, telephone numbers, email addresses, home addresses, or any other identifying information) that uniquely identifies or can be used to contact or locate a specific person.

The present disclosure recognizes that the use of personal information data can enhance a user's experience while using a computer system. For example, personal information data can be used for the benefit of users by changing how a computer system interacts with a user. Thus, enabling better user interactions. Additionally, other uses for personal information data that benefit the user are also contemplated by the present disclosure.

The present disclosure further contemplates that the use of a user's personal information data, in the present technology, impacts the user's privacy. As well, that the entities responsible for the collection, analysis, disclosure, transfer, storage, or other use of such personal information data will comply with well-established privacy policies and/or privacy practices. Particularly, the implementation and maintenance of industry or government standard privacy policies and practice is required for entities to keep personal information data private and secure. For example, entities should only collect personal information data for reasonable and legitimate uses within the entity and should not be shared or sold to outside entities. Additionally, the collection of personal information data should only occur after receiving information consent from the target users. Further, once such personal information data has been obtained, entities should take necessary steps to secure the collected personal information data from improper access or use. Therefore, entities should ensure their practices follow their established privacy policies and procedures, either internally or through third party evaluations to certify their practices.

Alternatively, the present disclosure also ensures that the functionality of the disclosed embodiments is not rendered inoperable due to the lack of all or a portion of such personal information data. The present disclosure considers embodiments that allow users to selectively block the use of, or access to, personal information data. Such inability to access personal information data can be provided through hardware components and/or software elements. For example, in the case of image capture, the present technology can be configured to allow users to select to “opt in” or “opt out” of participation in the collection of personal information data during registration for services. Thus, while the present disclosure is broadly directed to the use of personal information data in one or more various disclosed embodiments, the present disclosure also contemplates that the various embodiments can also be implemented without the use of such personal information data. For example, content can be displayed to users by inferring location based on non-personal information data or a bare minimum amount of personal information, such as the content being requested by the device associated with a user or other non-personal information.

What is claimed is:

1. A method, comprising:
at a computer system:
receiving a first image; and
after receiving the first image:
in accordance with a determination to send the first image to a first receiver:
generating a first neural network model corresponding to the first image; and
sending, to the first receiver, the first neural network model without sending the first image; and
in accordance with a determination to send the first image to a second receiver different from the first receiver, sending, to the second receiver, a second representation of the first image without sending a neural network model corresponding to the first image.

2. The method of claim 1, wherein generating a first neural network model corresponding to the first image includes:
down sampling the first image to generate a second image and a third image separate from the second image, wherein the second image is different from the first image, and wherein the third image is different from the first image; and
training the first neural network model using the second image and the third image.

3. The method of claim 2, wherein the second image does not include data of the first image included in the third image.

4. The method of claim 1, wherein the first neural network model is a first size, and wherein the first image is a second size larger than the first size.

5. The method of claim 1, wherein the first neural network model is a third size, and wherein the second representation is a fourth size smaller than the third size.

6. The method of claim 1, wherein the first image is received via a camera.

7. The method of claim 1, wherein the second representation is an encoded version of the first image, the method further comprising:
after receiving the first image and in accordance with a determination to send the first image to a third receiver different from the first receiver and the second receiver, sending, to the third receiver, the first image without sending the second representation and without sending a neural network model corresponding to the first image.

8. The method of claim 1, wherein the first neural network model is a Neural Radiance Field.

9. The method of claim 1, further comprising:
storing, in first long-term storage, the first neural network model.

10. The method of claim 1, further comprising:
in conjunction with sending the first neural network model, sending the second representation.

11. A non-transitory computer-readable storage medium storing one or more programs configured to be executed by one or more processors of a computer system, the one or more programs including instructions for:
receiving a first image; and
after receiving the first image:
in accordance with a determination to send the first image to a first receiver:
generating a first neural network model corresponding to the first image; and
sending, to the first receiver, the first neural network model without sending the first image; and
in accordance with a determination to send the first image to a second receiver different from the first receiver, sending, to the second receiver, a second representation of the first image without sending a neural network model corresponding to the first image.

12. A computer system, comprising:
one or more processors; and
memory storing one or more programs configured to be executed by the one or more processors, the one or more programs including instructions for:
receiving a first image; and
after receiving the first image:
in accordance with a determination to send the first image to a first receiver:
generating a first neural network model corresponding to the first image; and
sending, to the first receiver, the first neural network model without sending the first image; and
in accordance with a determination to send the first image to a second receiver different from the first receiver, sending, to the second receiver, a second representation of the first image without sending a neural network model corresponding to the first image.
